(19) United States
(12) Patent Application Publication
(10) Pub. No.: US 2014/0064127 A1
(43) Pub. Date: Mar. 6, 2014

(54) RANGING METHOD AND APPARATUS IN WIRELESS COMMUNICATION SYSTEM

(71) Applicants: Korea Advanced Institute of Science and Technology, Daejeon (KR); Samsung Electronics Co., Ltd., Suwon-si (KR)

(72) Inventors: Hyun-Jeong KANG, Seoul (KR); Jung-Min MOON, Seoul (KR); Dong-Ho CHO, Seoul (KR)

(73) Assignees: Korea Advanced Institute of Science and Technology, Daejeon (KR); Samsung Electronics Co., Ltd., Suwon-si (KR)

(21) Appl. No.: 14/016,817

(22) Filed: Sep. 3, 2013

(30) Foreign Application Priority Data
Sep. 4, 2012 (KR) 10-2012-0097823

(51) Int. Cl. H04W 24/02

(52) U.S. Cl. CPC H04W 24/02
USPC 370/252

(57) ABSTRACT

A ranging method and apparatus in a wireless communication system are provided. The ranging method of a Mobile Station (MS) includes selecting at least one Base Station (BS) for performing ranging, transmitting a ranging signal by using a common ranging region shared by a plurality of BSs, and receiving a response signal, including a ranging result of at least one BS which received the ranging signal, from a central controller.

### CROSS-REFERENCE TO RELATED APPLICATION(S)

This application claims the benefit under 35 U.S.C. §119(a) of a Korean patent application filed on Sep. 4, 2012 in the Korean Intellectual Property Office and assigned Serial No. 10-2012-0097823, the entire disclosure of which is hereby incorporated by reference.

### JOINT RESEARCH AGREEMENT

The present disclosure was made by or on behalf of the below listed parties to a joint research agreement. The joint research agreement was in effect on or before the date the present disclosure was made and the present disclosure was made as a result of activities undertaken within the scope of the joint research agreement. The parties to the joint research agreement are 1) Samsung Electronics Co., Ltd., and 2) Korea Advanced Institute of Science and Technology.

### TECHNICAL FIELD

The present disclosure relates to a ranging method and apparatus in a wireless communication system. More particularly, the present disclosure relates to a ranging method and apparatus for a plurality of base stations.

### BACKGROUND

FIG. 1 illustrates an example of a wireless communication system, in which a plurality of Base Stations (BSs) and Relay Stations (RSs) are present, according to the related art.

Referring to FIG. 1, a plurality of BSs 101 or RSs 111 and 112 are present in a wireless communication system. There is a rapidly growing interest on cooperative communication in which a communication service is provided for a Mobile Station (MS) 100 through cooperation between the plurality of BSs 101 and the RSs 111 and 112. Accordingly, there is a need for a method of effectively performing ranging on the plurality of BSs 101 or the RSs 111 and 112 by one MS 100 by considering the cooperative communication. In general, the ranging is a process for adjusting an exact time and frequency offset between the BS and the MS and for correcting Transmit (Tx) power of the MS.

Recently, dedicated ranging and common ranging are provided for the ranging with the plurality of BSs. The dedicated ranging is a scheme in which each of the plurality of BSs and RSs transmits a ranging signal by using a unique ranging region. That is, in the dedicated ranging, ranging is performed in such a manner that the plurality of BSs and RSs for which the MS intends to perform ranging are selected, and thereafter an additional ranging signal is transmitted for each of the BSs and RSs by using a unique ranging region for each of the selected BSs and RSs. However, the dedicated ranging has a disadvantage in that a time required to perform the ranging is increased in proportion to the number of BSs or RSs for performing the ranging.

On the other hand, the common ranging is a scheme in which the plurality of BSs and RSs share the ranging region with each other, and transmit the ranging signal by using the shared ranging region. That is, the common ranging transmits one ranging signal with respect to the plurality of BSs and RSs by using a common ranging region, and if the BS and the RS transmit a ranging result to a central controller, the central controller selects the plurality of BSs and RSs for the ranging of the MS on the basis of the ranging result. However, the common ranging has a problem in that it is difficult for the central controller to properly select the BS or the RS if a channel state is distorted due to fading at the moment of transmitting the ranging signal, because the common ranging can know only information on a channel between the MS and the BS or between the MS and the RS at a moment when the central controller transmits the ranging signal when using the common ranging. In addition, the common ranging also has a problem in that a BS and RS located in a position at which a service cannot be provided to the MS may be selected, because a plurality of BSs and RSs are selected by the central controller on the basis of only a ranging result without considering a movement of the MS. An example of which is shown in FIG. 2.

FIG. 2 illustrates a selected BS set when using a common ranging method according to the related art.

Referring to FIG. 2, as a result of transmitting a ranging signal by using a common ranging region before an MS 100 moves in operation 120, a situation may occur in which a central controller selects a BS 101 and an RS #1 111 in operation 121 but the MS 100 cannot receive a service from the RS #1 111 right after transmitting the ranging signal in practice and thus moves to a location at which the service can be provided from an RS #2 112 in operation 122.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a ranging method and apparatus for a plurality of Base Stations (BSs) and Relay Stations (RSs) in a wireless communication system.

Another aspect of the present disclosure is to provide a method and apparatus for selecting a plurality of BSs and RSs by a Mobile Station (MS), and for simultaneously performing ranging by using a common ranging region with respect to the selected plurality of BSs and RSs in a wireless communication system.

Another aspect of the present disclosure is to provide a method and apparatus for selecting a ranging code and a ranging slot by an MS in a wireless communication system.

Another aspect of the present disclosure is to provide a method and apparatus for reselecting a ranging code and a ranging slot by an MS with respect to at least one BS and RS for which ranging is not successfully performed among a plurality of selected BSs and RSs in a wireless communication system.

Another aspect of the present disclosure is to provide a method and apparatus for determining a plurality of BSs and RSs, selected by an MS, by a central controller on the basis of a ranging code and ranging slot of the MS in a wireless communication system.

In accordance with an aspect of the present disclosure, a ranging method of an MS in a wireless communication system is provided. The method includes selecting at least one BS for performing ranging, transmitting a ranging signal by using a common ranging region shared by a plurality of BSs, and receiving a response signal, including a ranging result of at least one BS which received the ranging signal, from a central controller.

In accordance with another aspect of the present disclosure, a method of a central controller for performing ranging of an MS in a wireless communication system is provided. The method includes receiving a ranging result on a ranging signal of the MS from at least one BS, and transmitting the ranging result of the at least one BS to the MS.

In accordance with another aspect of the present disclosure, an MS apparatus for performing ranging in a wireless communication is provided. The apparatus includes a transceiver configured to transmit and receive a signal, and a controller configured to select at least one BS for performing ranging, to transmit a ranging signal by using a common ranging region shared by a plurality of BSs, and to receive a response signal, including a ranging result of at least one BS which received the ranging signal, from a central controller.

In accordance with another aspect of the present disclosure, a center controller apparatus for performing ranging of an MS in a wireless communication system is provided. The apparatus includes a transceiver for configured to transmit and receive a signal, a controller configured to receive a ranging result on a ranging signal of the MS from at least one BS, and to transmit the ranging result of the at least one BS to the MS.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates an example of a wireless communication system, in which a plurality of Base Stations (BSs) and Relay Stations (RSs) are present, according to the related art;

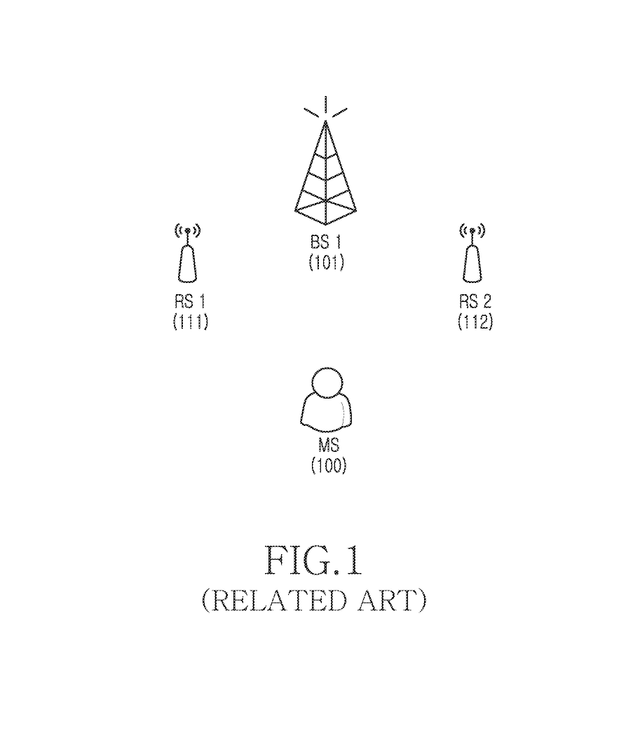

FIG. 2 illustrates a selected BS set when using a common ranging method according to the related art;

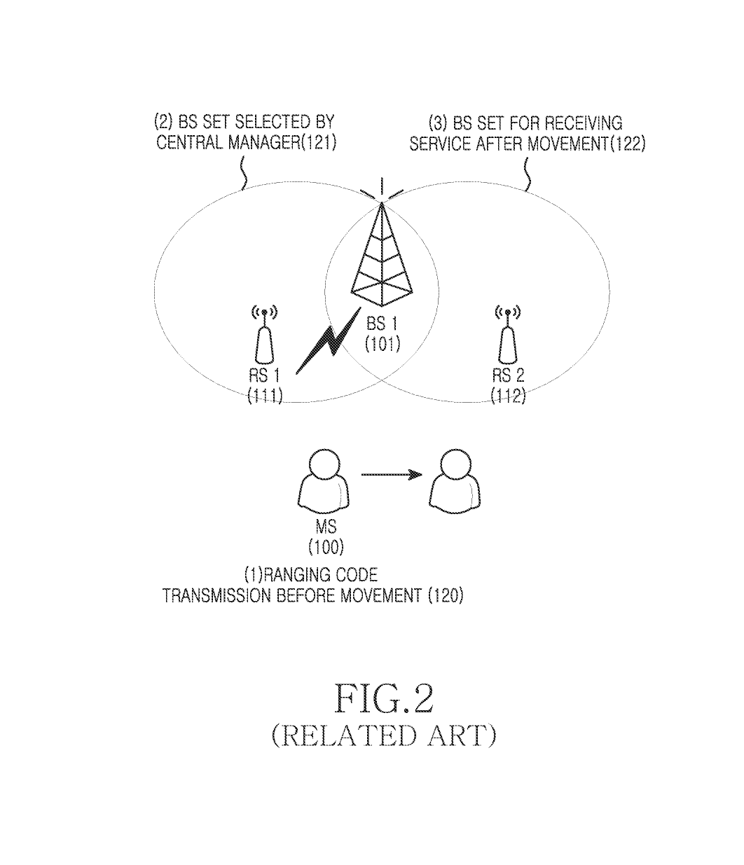

FIG. 3 is a flowchart illustrating a ranging process in a wireless communication system according to an embodiment of the present disclosure;

FIG. 4 illustrates a BS set selected by a Mobile Station (MS) in a wireless communication system according to an embodiment of the present disclosure;

FIG. 5 illustrates an example of selecting a ranging code and a ranging slot in a wireless communication system according to an embodiment of the present disclosure;

FIG. 6A illustrates a ranging result of each BS which receives a ranging signal in a wireless communication system according to an embodiment of the present disclosure;

FIG. 6B illustrates an example of an index of a BS selected by an MS in a wireless communication system according to an embodiment of the present disclosure;

FIG. 7 illustrates an example of reselecting a ranging code and a ranging slot in a wireless communication system according to an embodiment of the present disclosure;

FIG. 8 illustrates an example of adaptively changing a ranging code and a ranging slot by an MS in a wireless communication system according to an embodiment of the present disclosure;

FIG. 9 illustrates an example of adaptively changing a ranging code and a ranging slot by each MS when a plurality of MSs simultaneously attempt ranging in a wireless communication system according to an embodiment of the present disclosure;

FIG. 10 illustrates an example in which each MS's ranging code and ranging slot collide when a plurality of MSs simultaneously attempt ranging in a wireless communication system according to an embodiment of the present disclosure;

FIG. 11 illustrates an example of avoiding a collision of each MS's ranging code and ranging slot when a plurality of MSs simultaneously attempt ranging in a wireless communication system according to an embodiment of the present disclosure;

FIG. 12 illustrates an example of selecting the same ranging code and slot with respect to a different index in a wireless communication system according to an embodiment of the present disclosure;

FIG. 13 is a flowchart illustrating a ranging process of an MS in a wireless communication system according to an embodiment of the present disclosure;

FIG. 14 is a flowchart illustrating a ranging process of a BS in a wireless communication according to an embodiment of the present disclosure;

FIG. 15 is a flowchart illustrating a process of a central controller for performing ranging in a wireless communication according to an embodiment of the present disclosure;

FIG. 16 is a block diagram of an MS in a wireless communication system according to an embodiment of the present disclosure;

FIG. 17 is a block diagram of a BS in a wireless communication system according to an embodiment of the present disclosure; and

FIG. 18 is a block diagram of a central controller in a wireless communication system according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and configurations may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure described hereinafter relates to a method and apparatus for performing ranging on a plurality of Base Stations (BSs) in a wireless communication system. The present disclosure can equally apply to all types of ranging, such as initial ranging, periodic ranging, bandwidth request ranging, and handover ranging. Although a wireless communication system in which a plurality of BSs are present is assumed in the present disclosure for clarity, the present disclosure can also equally apply to a wireless communication system in which a plurality of BSs and Relay Stations (RSs) are present. That is, the plurality of BSs may include at least one RS in the following description.

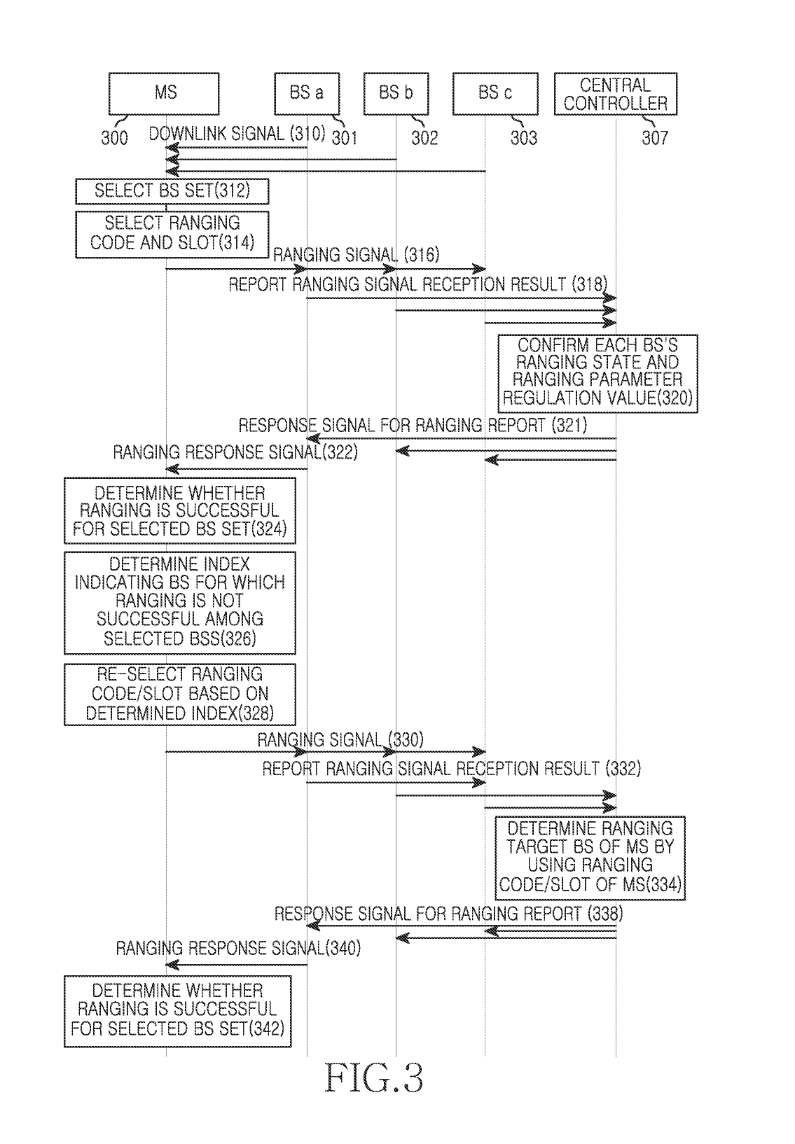

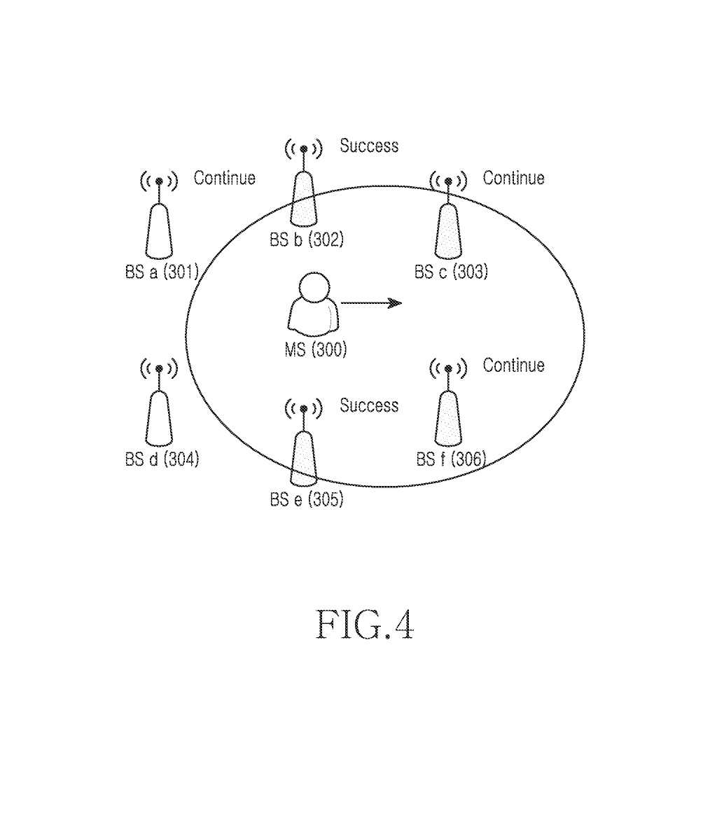

FIG. 3 is a flowchart illustrating a ranging process in a wireless communication system according to an embodiment of the present disclosure. Although only operations of a BS a 301, a BS b 302, and a BS c 303 are illustrated herein, a case where a BS a 301 to a BS f 306 are present is assumed in the following description as illustrated in FIG. 4. FIG. 4 illustrates a BS set selected by a Mobile Station (MS) in a wireless communication system according to an embodiment of the present disclosure.

Referring to FIG. 3, an MS 300 receives a downlink signal from a plurality of BSs 301 to 306 at operation 310, and selects a BS set for performing ranging on the basis of the received downlink signal (e.g., a downlink preamble) at operation 312. Herein, the MS 300 may select the BS set on the basis of at least one of downlink signal's reception strength, a downlink signal's signal-to-noise ratio, each BS's load information, and each BS's type and ranging class. For example, for initial ranging, the MS 300 may select BSs of which downlink signal strength is greater than or equal to a threshold. For another example, for ranging which occurs while receiving a service, the MS 300 may select a BS of which received downlink signal strength is greater than or equal to the threshold and a BS of which an interference amount is great. This is only for the embodiment of the present disclosure, and thus the BS set of the present disclosure may be selected by using a well-known Coordinate Multi-Point (CoMP) set configuration method, a cell clustering method, a handoff method, etc. It is assumed herein that the MS 300 selects the BS b 302, the BS c 303, the BS e 305, and the BS f 306 as the BS set in a situation where the BS a 301 to the BS f 306 are present as illustrated in FIG. 4.

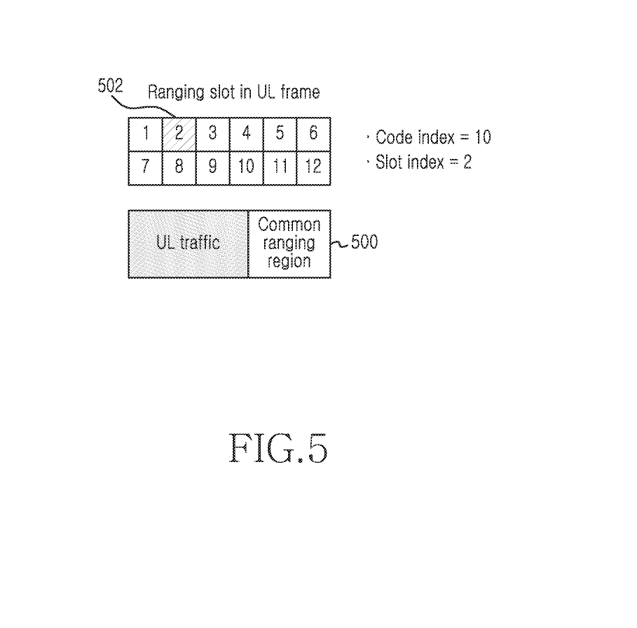

At operation 314, the MS 300 selects a ranging code and a ranging slot. At operation 316, the MS 300 transmits a ranging signal including the selected ranging code through the selected ranging slot. In the present disclosure, a plurality of BSs share a ranging region, that is, the ranging code and the ranging slot. Therefore, the ranging signal transmitted by the MS 300 may be discovered by the plurality of BSs which share the ranging code and the ranging slot, as illustrated in FIG. 5.

FIG. 5 illustrates an example of selecting a ranging code and a ranging slot in a wireless communication system according to an embodiment of the present disclosure.

Referring to FIG. 5, the MS 300 may select a ranging slot 502 having an index 2 and a ranging code having an index 10 either randomly or according to a predetermined method for initial transmission of a ranging signal, and may transmit the ranging signal included in the selected ranging code through the selected ranging slot 502 in a common ranging region 500. In this case, the transmitted ranging signal may be found by the plurality of BSs 301 to 306 which share the common ranging region 500. In addition, although not shown, the MS 300 determines Transmit (Tx) power for the transmission of the ranging signal. In this case, the MS 300 may measure a path loss for each BS included in the selected BS, and thereafter may determine the Tx power on the basis of the greatest path loss value. For example, the Tx power may be determined by subtracting the greatest path loss value from target Receive (Rx) power of the BS.

Hereafter, the BSs 301, 302, 303, 305, and 306 which receive the ranging signal among the plurality of BSs 301 to 306 determine whether there is a need to regulate time, frequency, and power on the basis of the received ranging signal. In this case, if it is determined that the regulation of the time, frequency, and power is not necessary, the BSs 301, 302, 303, 305, and 306 determine that ranging is successful, and otherwise if it is determined that the regulation of the time, frequency, and power is necessary, a ranging parameter regulation value is generated to regulate the time, frequency, and power if it is determined that ranging is not successful. Thereafter, at operation 318, the BSs 301, 302, 303, 305, and 306 report a ranging signal reception result to the central controller 307. In this case, the ranging signal reception result may be transmitted by using a ranging response message. The ranging signal reception result includes at least one of a ranging code index and ranging slot index for a ranging signal of the MS, a ranging success/failure state of each BS, and a ranging parameter regulation value of a BS for which ranging is not successful. Herein, the ranging parameter regulation value includes at least one of a time regulation value, a frequency regulation value, and a power regulation value. For example, as illustrated in FIG. 4, it is assumed that, as a result of receiving the ranging signal of the MS 300 by the BS a 301, the BS b 302, BS c 303, the BS e 305, and the BS f 306 among the plurality of BSs 301 to 306, ranging is successful for the BS b 302 and the BS e 305, and ranging is not successful for the BS a 301, the BS c 303, and the BS f 306. In this case, the BS b 302 and the BS e 305 may transmit to the central controller 307 a ranging response signal including a ranging code index and ranging slot index for the ranging signal of the MS 300 and a “success” state information indicating a ranging success. On the other hand, the BS a 301, the BS c 303, and the BS f 306 may transmit to the central controller 307 the ranging response signal including the ranging code index and ranging slot index for the ranging signal of the MS 300, a “continue” state information indicating a ranging failure, and a ranging parameter regulation value.

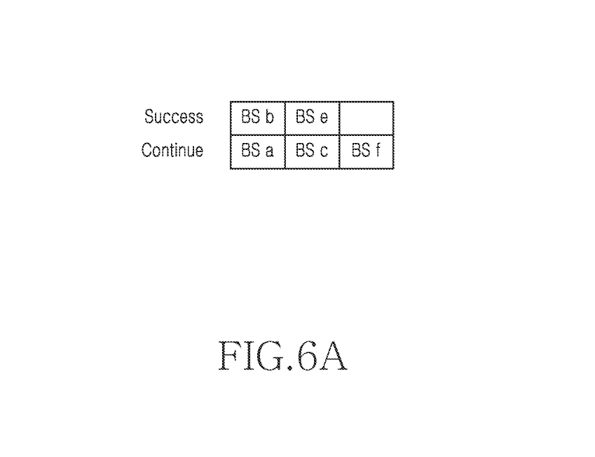

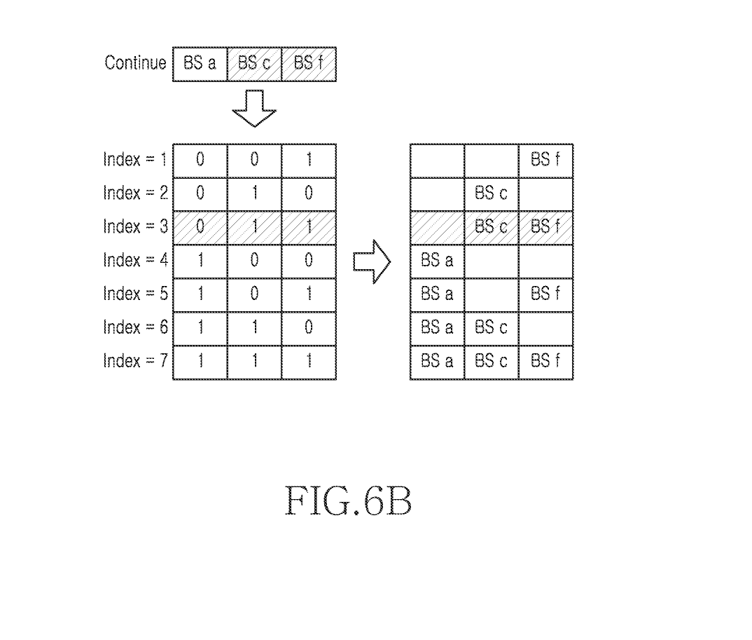

At operation 320, the central controller 307 confirms each BS's ranging state, that is, a ranging success/failure state, and a ranging parameter regulation value of a BS for which ranging is not successful, by using a ranging signal reception result received from the plurality of BSs 301, 302, 303, 305, and 306. At operation 321, the central controller 307 transmits a response signal for a ranging report to the plurality of BSs 301, 302, 303, 305, and 306. In this case, the central controller 307 selects one BS (e.g., the BS a 301) among the plurality of BSs 301, 302, 303, 305, and 306, and requests to transmit ranging result information to the MS 300 by adding information confirmed at operation 320, i.e., the ranging result information, to a response signal transmitted to the selected BS. Then, at operation 322, the BS a 301 requested to transmit the ranging result information transmits the ranging result information to the MS 300. Herein, each BS's ranging state information transmitted by the central controller 307 to the MS 300 via the selected BS a 301 is configured as illustrated in FIG. 6A.

FIG. 6A illustrates a ranging result of each BS which receives a ranging signal in a wireless communication system according to an embodiment of the present disclosure.

Referring to FIG. 6A, each BS's ranging state information transmitted by the central controller 307 to the MS 300 via the selected BS a 301 is configured such that a BS for which ranging is successful and a BS for which ranging is not successful are distinguished from each other.

At operation 324, the MS 300 determines whether ranging is successful for the BS set selected at operation 312 on the ranging result information received from the BS a 301. If ranging is successful for all BSs included in the BS set, the MS 300 may skip the subsequent steps and end the ranging process.

If ranging is not successful for all BSs included in the BS set, the MS 300 determines an index indicating a BS for which ranging is not successful in the selected BS set on the basis of the determination result of operation 326. That is, among the BS b 302, BS c 303, BS e 305, and BS f 306 selected at operation 312, the MS 300 determines that ranging is successful for the BS b 302 and the BS e 305, and determines that ranging is not successful for the BS c 303 and the BS f 306. Thereafter, the MS 300 determines an index indicating the BS c 303 and the BS f 306 according to a method agreed in advance with the central controller 307. In this case, the MS 300 and the central controller 307 may indicate a BS for which ranging is continuously performed by the MS, by using a combination of BSs of which ranging state information is “continue”.

FIG. 6B illustrates an example of an index of a BS selected by an MS in a wireless communication system according to an embodiment of the present disclosure.

For example, referring to FIGS. 6A and 6B, if there are three BSs of which ranging state information is “continue”, the total number of combinations that can be generated is 2³−1, i.e., 7. Therefore, each of the MS 300 and the central controller 307 may generate a table expressed in a binary system ranges from 1 to 7 as illustrated in FIG. 6B.

Thereafter, the MS 300 may generate 7 BS combinations by multiplying {BS a, BS c, BS f} indicating three BSs of which ranging state information is “continue” by the values of the table, and may select an index 3 indicating a combination of the BS c 303 and the BS f 306 among the generated 7 BS combinations. Herein, in order to generate the same BS combination between the MS 300 and the central controller 307, the MS 300 and the central controller 307 need to maintain an order of the ranging state information transmitted from the central controller 307 to the MS 300.

At operation 328, in order to reperform ranging on BSs for which ranging is not successful in the selected BS set, the MS 300 reselects a ranging code and a ranging slot on the basis of the index determined at operation 326. In this case, the MS 300 may reselect the ranging code and the ranging slot by using Equation (1) below.

next ranging code index=mod{current code index+α*BS set index, total number of codes}

next ranging slot index=mod{current slot index+β*BS set index, total number of slots} Equation (1)

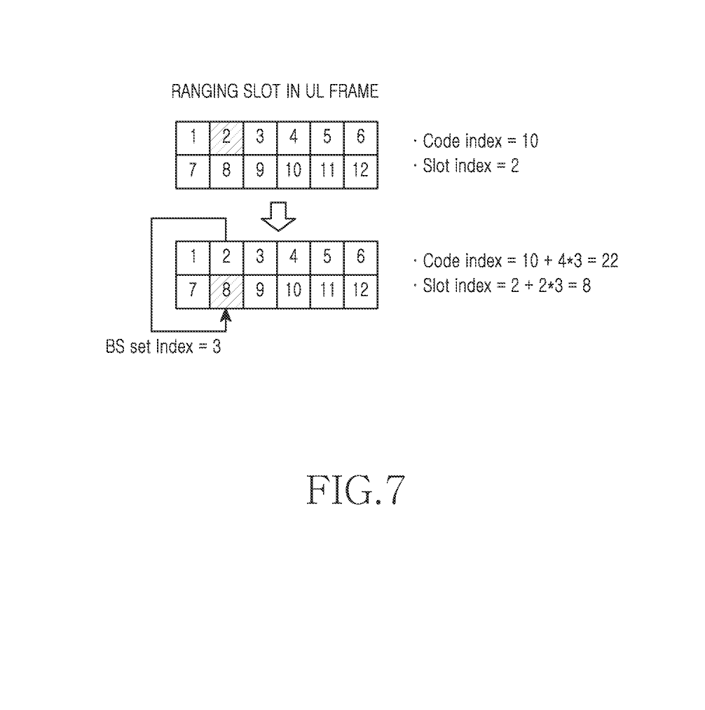

In Equation (1), the current code index and the current slot index imply a current ranging code index and ranging slot index selected to perform a corresponding ranging process. In addition, α denotes a ranging code hopping unit, and β denotes a ranging slot hopping unit. The values α and β are shared by the MS, the BS, and the central controller by using a downlink control message. In addition, the BS set index implies a BS combination index, and the total number of codes and the total number of slots imply the total number of ranging codes and the total number of ranging slots shared by a plurality of BSs. For example, consider that which is illustrated in FIG. 7.

FIG. 7 illustrates an example of reselecting a ranging code and a ranging slot in a wireless communication system according to an embodiment of the present disclosure.

Referring to FIG. 7, if an index of a ranging code initially selected for corresponding ranging by the MS 300 is 10, an index of a ranging slot is 2, a BS combination index is 3, a ranging code hopping unit a is 4, and a ranging slot hopping unit 13 is 2, then the BS 300 may determine a reselected ranging code index to 22(10+4*3) and a reselected ranging slot index to 8(2+2*3) according to Equation (1).

At operation 330, the MS 300 regulates time, frequency, and Tx power on the basis of a ranging parameter regulation value, and transmits a reselected ranging code by using a reselected ranging slot.

Thereafter, among the plurality of BSs 301 to 306, the BSs 301, 302, 303, 305, and 306 which receive a ranging signal determine whether there is a need to regulate the time, frequency, and power on the basis of the receiving ranging signal, and determine whether ranging is successful. In this case, a BS for which ranging is not successful generates a ranging parameter regulation value for regulating the time, the frequency, and the power. At operation 332, the plurality of BSs 301, 302, 303, 305, and 306 report a ranging signal reception result to the central controller 307. In this case, the ranging signal reception result may be transmitted by using a ranging response message. The ranging signal reception result includes at least one of a ranging code index and ranging slot index for a ranging signal of the MS, a ranging success/failure of each BS, and a ranging parameter regulation value of a BS for which ranging is not successful. Herein, the ranging parameter regulation value includes at least one of a time regulation value, a frequency regulation value, and a power regulation value.

At operation 334, the central controller 307 confirms a ranging code index and ranging slot index reselected by the MS 300 from the ranging signal reception result received from the plurality of BSs 301, 302, 303, 305, and 306, and determines a ranging target BS, i.e., a BS for which the MS 300 intends to perform ranging on the basis of the confirmed ranging code index and ranging slot index. Herein, the central controller 307 may determine the ranging target BS of the MS 300 by acquiring a BS combination index according to Equation (1) above. That is, since the central controller 307 is aware of all other parameters except for the BS combination index among the parameters included in Equation (1), the central controller 307 can calculate the BS combination index, and can confirm BSs indicated by the BS combination index by using the table of FIG. 6B. Thereafter, although not shown, the central controller 307 may confirm ranging result information on the ranging target BS (e.g., the BS c 303 and the BS f 306), that is, ranging state information indicating whether ranging is successful for a corresponding BS, and if the ranging is not successful, may confirm a ranging parameter regulation value. Herein, since the central controller 307 has already determined the BS for which ranging is performed by the MS 300, the central controller 307 may allocate the reselected ranging code and ranging slot as a dedicated ranging code and ranging slot of the MS.

At operation 338, the central controller 307 transmits a response signal for a ranging report to the plurality of BSs 301, 302, 303, 305, and 306. In this case, the central controller 307 selects one BS (e.g., the BS a 301) among the plurality of BSs 301, 302, 303, 305, and 306, and requests to transmit ranging result information to the MS 300 by adding the ranging result information to a response signal transmitted to the selected BS. Then, at operation 340, the BS a 301 requested to transmit the ranging result information transmits the ranging result information to the MS 300.

At operation 342, the MS 300 determines whether ranging is successful for the BS set selected at operation 312 on the ranging result information received from the BS a 301. If ranging is successful for all BSs included in the BS set, the MS 300 ends the ranging process of the present disclosure. Otherwise, if ranging is not successful for all BSs included in the BS set, returning to operation 324, the MS 300 determines subsequent steps, and thus the MS 300, the plurality of BSs 301 to 306, and the central controller 307 repeat operations 324 to 342.

A situation in which one MS performs ranging is assumed in the aforementioned description.

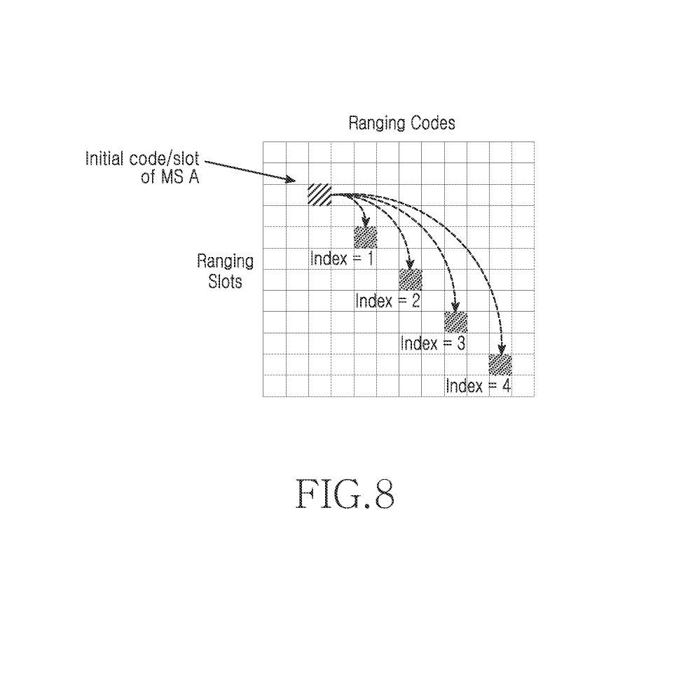

FIG. 8 illustrates an example of adaptively changing a ranging code and a ranging slot by an MS in a wireless communication system according to an embodiment of the present disclosure.

Referring to FIG. 8, a central controller can determine a ranging code and ranging slot which vary whenever the ranging is attempted by the MS.

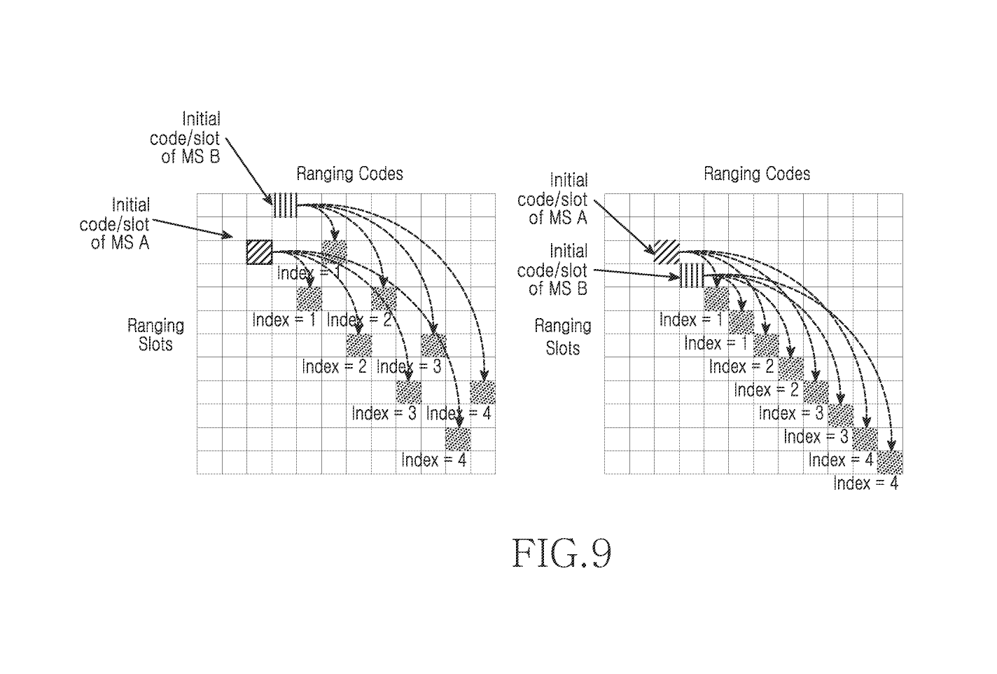

However, the ranging may be simultaneously performed by a plurality of MSs in an actual wireless environment. Accordingly, when the ranging is simultaneously performed by the plurality of MSs, a method of selecting a ranging code and a slot index to prevent ranging signals for the plurality of MSs from colliding with each other will be additionally described. A case where α and β are set to 2 will be assumed herein. Consider that which is illustrated in FIG. 9.

FIG. 9 illustrates an example of adaptively changing a ranging code and a ranging slot by each MS when a plurality of MSs simultaneously attempt ranging in a wireless communication system according to an embodiment of the present disclosure.

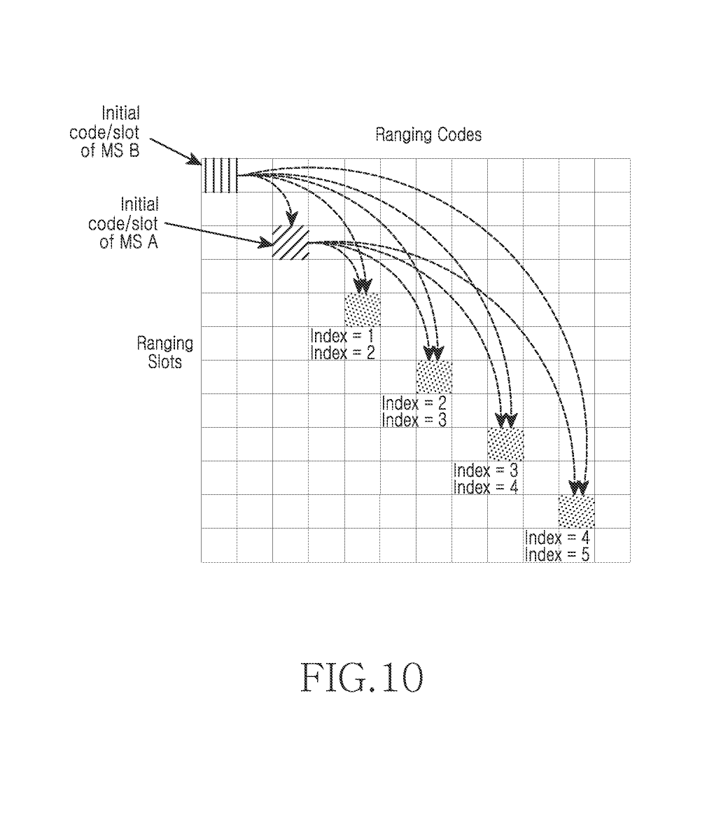

Referring to FIG. 9, if ranging codes and ranging slots for MSs A and B are selected, reselected ranging codes and ranging slots of the MSs A and B do not overlap regardless of which BS combination index is selected by the MSs A and B. On the other hand, consider that which is illustrated in FIG. 10.

FIG. 10 illustrates an example in which each MS's ranging code and ranging slot collide when a plurality of MSs simultaneously attempt ranging in a wireless communication system according to an embodiment of the present disclosure.

Referring to FIG. 10, if it is assumed a case where ranging codes and ranging slots of MSs A and B are selected, a reselected ranging code and a ranging slot index for a case where the MS A selects a BS combination index 1 may be set to be equal to a reselected ranging code and a ranging slot index for a case where the MS B selects a BS combination index 2. In this case, a situation where retransmitted ranging signals of the MSs A and B collide may occur, and it becomes difficult for the central controller to determine whether the ranging signal is for the MS A or the MS B.

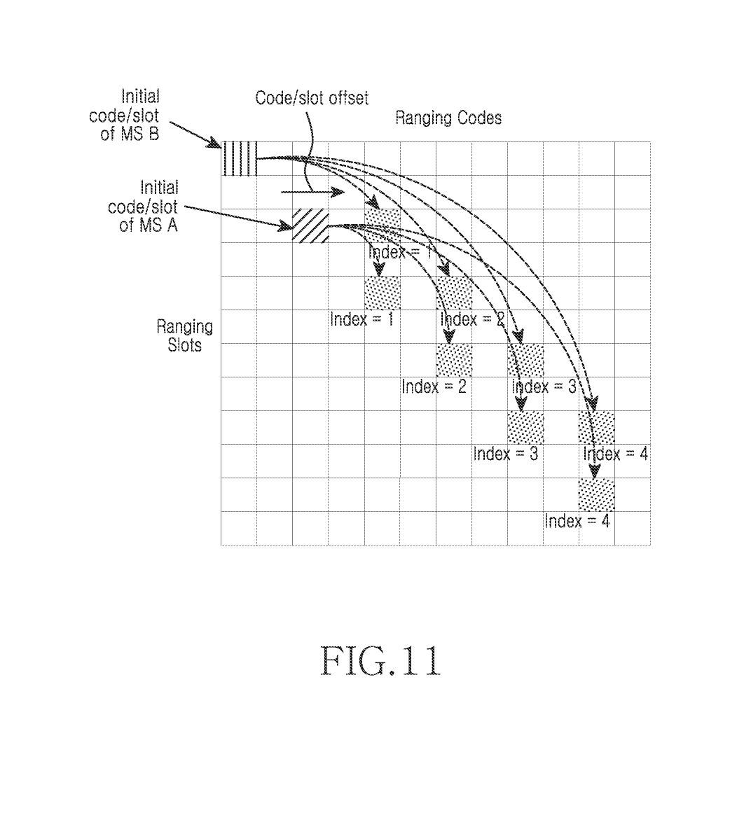

Therefore, in order to address this situation, the present disclosure proposes a method for detecting a situation where a plurality of MSs simultaneously attempt ranging, and upon the detection of the situation where the plurality of MSs simultaneously attempt the ranging, for predicting whether a ranging code and a ranging slot collide for the plurality of MSs, and if the collision is predicted, for providing a code offset and slot offset to be used in the determination of the ranging code and the ranging slot to at least one MS among corresponding MSs. For example, as illustrated in FIG. 10, if there is a possibility that the ranging codes and ranging slots of the MSs A and B are set to the same values, the code offset and the slot offset are provided to the MS B. Then, the MS B reselects a ranging code and a ranging slot by additionally considering a code offset and a slot offset as illustrated in Equation (2) below. Accordingly, the ranging codes and ranging slots of the MSs A and B are not set to the same values, but can be clearly distinguished as illustrated in FIG. 11.

FIG. 11 illustrates an example of avoiding a collision of each MS's ranging code and ranging slot when a plurality of MSs simultaneously attempt ranging in a wireless communication system according to an embodiment of the present disclosure.

Equation (2) below shows a method of reselecting a ranging code and slot by considering a code offset and a slot offset.

next ranging code index=mod{current code index+α*BS set index+code offset, total number of codes}

next ranging slot index=mod{current slot index+β*BS set index+slot offset, total number of slots} Equation (2)

In Equation (2), the current code index and the current slot index imply a current ranging code index and ranging slot index selected to perform a corresponding ranging process. In addition, α denotes a ranging code hopping unit, and β denotes a ranging slot hopping unit. The values α and β are shared by the MS, the BS, and the central controller by using a downlink control message. In addition, the BS set index implies a BS combination index, and the total number of codes and the total number of slots imply the total number of ranging codes and the total number of ranging slots shared by a plurality of BSs. In addition, the code offset and the slot offset imply a code offset and slot offset received from the central controller 307 to avoid a collision of the ranging code and the ranging slot. Herein, the code offset and the slot offset may be transmitted by using a ranging response signal, and may be transmitted by using an additional downlink control signal.

Further, in the above description, α and β may be set to the same value for all BSs. According to the embodiment of the present disclosure, the central controller may determine the values α and β which satisfy Equation (3) below.

αk≠cN_{c} OR βk≠cNₛ, where k=1, 2, . . . , M for all c ∈ N Equation (3)

In Equation (3), N_{c} denotes the total number of ranging codes, Nₛ denotes the total number of ranging slots, M denotes the number of BS combinations, and N denotes a natural number set.

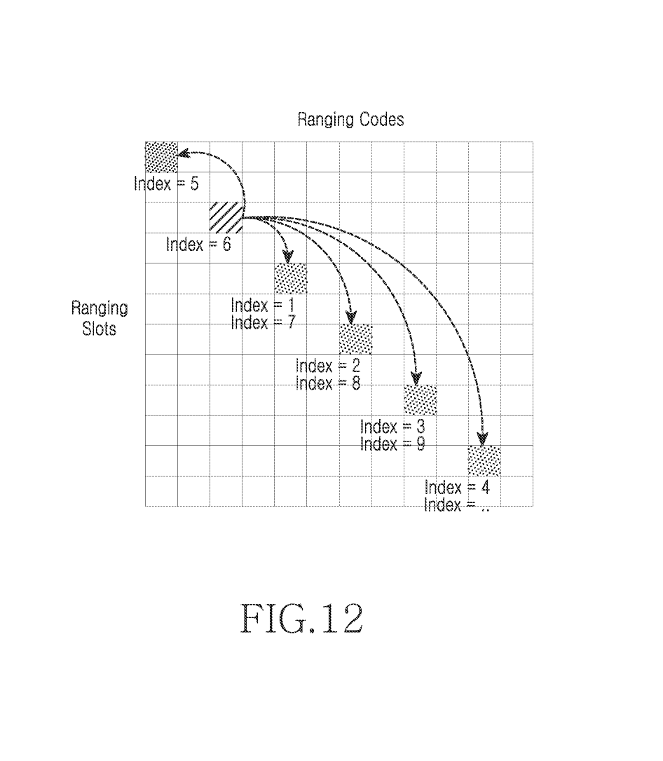

FIG. 12 illustrates an example of selecting the same ranging code and slot with respect to a different index in a wireless communication system according to an embodiment of the present disclosure.

The reason for determining α and β as described in Equation (3) above is for mapping one ranging code and ranging slot with respect to one index. In other words, as illustrated in FIG. 12, if the number of ranging codes and the number of slots are 12 and α and β are 2, a reselected ranging code and a reselected ranging slot do not overlap until BS combination indices 1 to 6, but for a BS combination index 7 or higher, one ranging code and ranging slot are mapped to two BS combination indices. That is, the same ranging code and ranging slot are reselected for a case where a BS combination index 1 is used for a specific ranging code and ranging slot and for a case where the BS combination index 7 is used. In this case, since the central controller cannot clearly determine whether a BS combination index selected by the MS is 1 or 7, in order to avoid such a situation, α and β may be determined by using Equation (3) above.

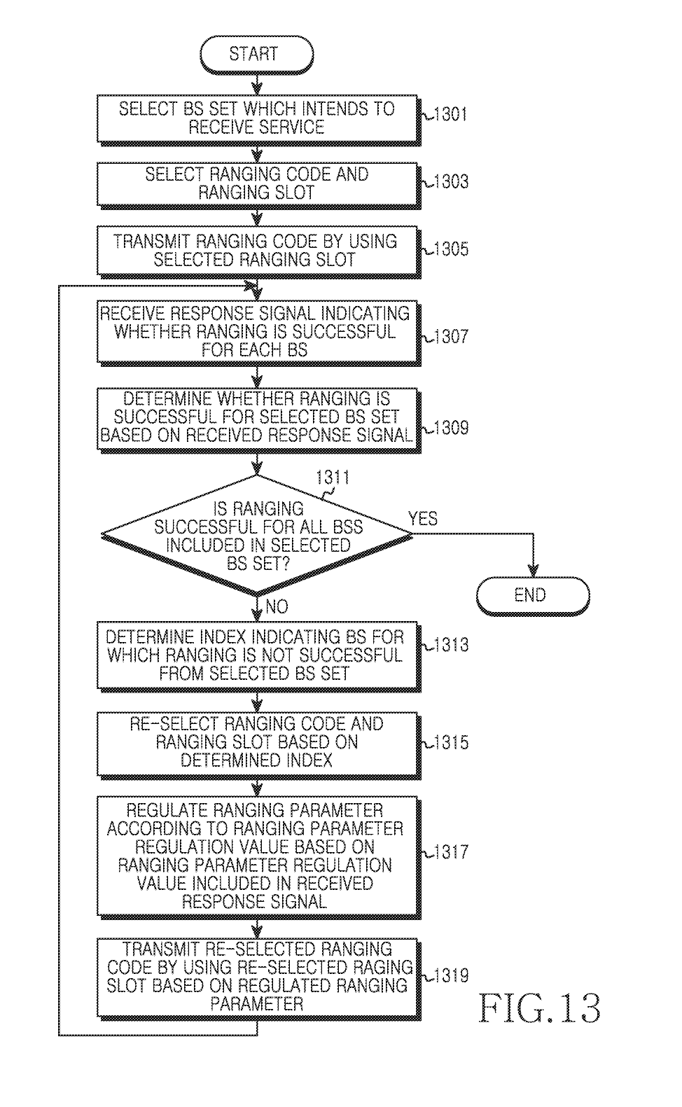

FIG. 13 is a flowchart illustrating a ranging process of an MS in a wireless communication system according to an embodiment of the present disclosure.

Referring to FIG. 13, at operation 1301, the MS 300 receives a downlink signal from the plurality of BSs 301 to 306, and selects a BS set which intends to receive a signal, that is, a BS set for performing ranging, on the basis of the received downlink signal (e.g., a downlink preamble). Herein, the MS 300 may select the BS set on the basis of at least one of downlink signal's reception strength, a downlink signal's signal-to-noise ratio, each BS's load information, and each BS's type and ranging class. For example, for initial ranging, the MS 300 may select BSs of which downlink signal strength is greater than or equal to a threshold, and for ranging which occurs during receiving a service, the MS 300 may select a BS of which received downlink signal strength is greater than or equal to the threshold and a BS of which an interference amount is great. This is only for the embodiment of the present disclosure, and thus the BS set of the present disclosure may be selected by using a well-known CoMP set configuration method, a cell clustering method, a handoff method, etc. It is assumed herein that the MS 300 selects the BS b 302, the BS c 303, the BS e 305, and the BS f 306 as the BS set in a situation where the BS a 301 to the BS f 306 are present as illustrated in FIG. 4.

At operation 1303, the MS 300 selects a ranging code and a ranging slot. At operation 1305, the MS 300 transmits a ranging signal including the selected ranging code through the selected ranging slot. In the present disclosure, a plurality of BSs share a ranging region, that is, the ranging code and the ranging slot, and thus the plurality of BSs can find a ranging signal transmitted by the MS 300. That is, as illustrated in FIG. 5, the MS 300 may select a ranging slot 502 having an index 2 and a ranging code having an index 10 either randomly or according to a predetermined method for initial transmission of a ranging signal, and may transmit a ranging signal included in the selected ranging code through the selected ranging slot 502 in a common ranging region 500. In this case, the transmitted ranging signal may be found by the plurality of BSs 301 to 306 which share the common ranging region 500. In addition, although not shown, the MS 300 may measure a path loss for each BS included in the selected BS, and thereafter may determine Tx power for the ranging signal on the basis of the greatest path loss value. For example, the Tx power of the ranging signal may be determined by subtracting the greatest path loss value from a target Rx power of the BS.

At operation 1307, the MS 300 receives from a specific BS a response signal indicating whether ranging is successful for each of the plurality of BSs. Herein, the specific BS may be a BS determined by the central controller among a plurality of BSs for finding the ranging signal.

At operation 1309, the MS 300 determines whether ranging is successful for a BS set selected at operation 1301 on the basis of a response signal received from a specific BS. At operation 1311, the MS 300 determines whether ranging is successful for all BSs included in the selected BS set. For example, the MS 300 analyzes the received response signal to determine whether state information of each of the BS b 302, BS c 303, BS e 305, and BS f 306 included in the selected set is “success” or “continue”. If the state information of all BSs included in the selected set is “success”, it is determined that ranging is successful for all BSs included in the selected BS set, and if state information of at least one BS is “continue” among the BSs included in the selected set, it is determined that ranging is not successful for all BSs included in the selected BS set. If ranging is successful for all BSs included in the selected BS set, the MS 300 may skip the subsequent steps and end the ranging process of the present disclosure.

Otherwise, if ranging is not successful for all BSs included in the selected BS set, proceeding to operation 1313, an index indicating a BS for which ranging is not successful is determined in the selected BS set. For example, if ranging state information for the BS c 303 and the BS f 306 is “continue” among the selected BSs, i.e., the BS b 302, the BS c 303, the BS e 305, and the BS f 306, an index indicating the BS c 303 and the BS f 306 is determined according to a predetermined method. For example, as illustrated in FIGS. 6A and 6B, if the number of BSs of which ranging state information is “continue” is N, the MS 300 can generate a table which indicates a number in the range of 1 to 2^{N}−1 in a binary system from the received response signal, and can generate 7 BS combinations by multiplying {BS a, BS c, BS f} indicating two BSs of which ranging state information is “continue” by the values of the generated table. Thereafter, the MS 300 may select an index 3 indicating a combination of the BS c 303 and the BS f 306 among the generated 7 BS combinations.

At operation 1315, the MS 300 reselects a ranging code and a ranging slot on the basis of the determined index. In this case, the MS 300 may reselect the ranging code and the ranging slot by using Equation (1) or Equation (2). Herein, the reason of reselecting the ranging code and the ranging slot on the basis of the determined index is for reporting information on BSs for which ranging is not successful in the selected BS set to the central controller.

At operation 1317, the MS 300 regulates ranging parameters according to a ranging parameter regulation value on the basis of a ranging parameter regulation value included in the received response signal. At operation 1319, the MS 300 transmits a reselected ranging code by using a reselected ranging slot on the basis of the regulated ranging parameter. Herein, the ranging parameter implies time, frequency, and Tx power.

Thereafter, returning to operation 1307, the MS 300 repeats the subsequent steps.

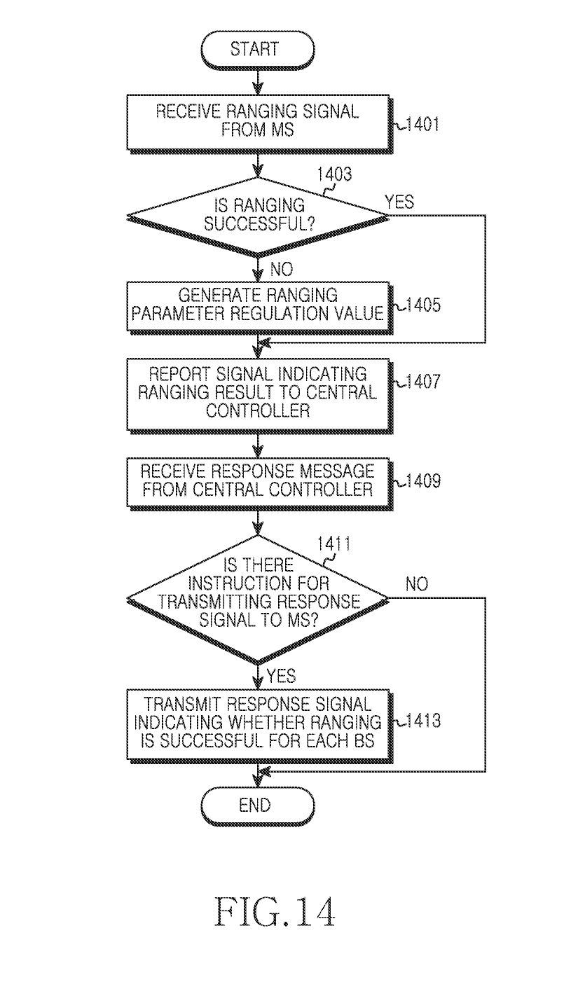

FIG. 14 is a flowchart illustrating a ranging process of a BS in a wireless communication according to an embodiment of the present disclosure.

Referring to FIG. 14, each of the BSs 301 to 306 receives a ranging signal from the MS at operation 1401, and determines whether ranging is successful at operation 1403. That is, each of the BSs 301 to 306 determines whether there is a need for regulating a ranging parameter such as time, frequency, and power on the basis of the received ranging signal, and if it is determined that the regulation of the ranging parameter is not necessary, determines that the ranging is successful, and otherwise if it is determined that the regulation of the ranging parameter is necessary, determines that the ranging is not successful. If the ranging is successful, each of the BSs 301 to 306 directly proceeds to operation 1407.

Otherwise, if the ranging is not successful, each of the BSs 301 to 306 generates a ranging parameter regulation value for regulating time, frequency, and power at operation 1405. Thereafter, the BS reports a ranging result to the central controller 307 at operation 1407. In this case, the ranging signal reception result may be transmitted by using a ranging response message. The ranging signal reception result includes at least one of a ranging code index and ranging slot index for a ranging signal of the MS 300, ranging state information indicating whether ranging of a corresponding BS is successful, and a ranging parameter regulation value for a case where the ranging is not successful.

Thereafter, each of the BSs 301 to 306 receives a response message from the central controller 307 at operation 1409, and determines whether there is an instruction for transmitting a response signal from the central controller 307 to the MS 300 on the basis of the received response message at operation 1411. If there is no instruction for transmitting the response signal to the MS, the BS ends the ranging process.

Otherwise, if there is the instruction for transmitting the response signal to the MS, proceeding to operation 1413, each of the BSs 301 to 306 transmits to the MS a response signal indicating ranging result information of each BS. Herein, as illustrated in FIG. 6A, the ranging result information is configured such that a BS for which ranging is successful is distinguished from a BS for which ranging is not successful, and includes ranging parameter information of the BS for which ranging is not successful.

Thereafter, each of the BSs 301 to 306 ends the ranging process.

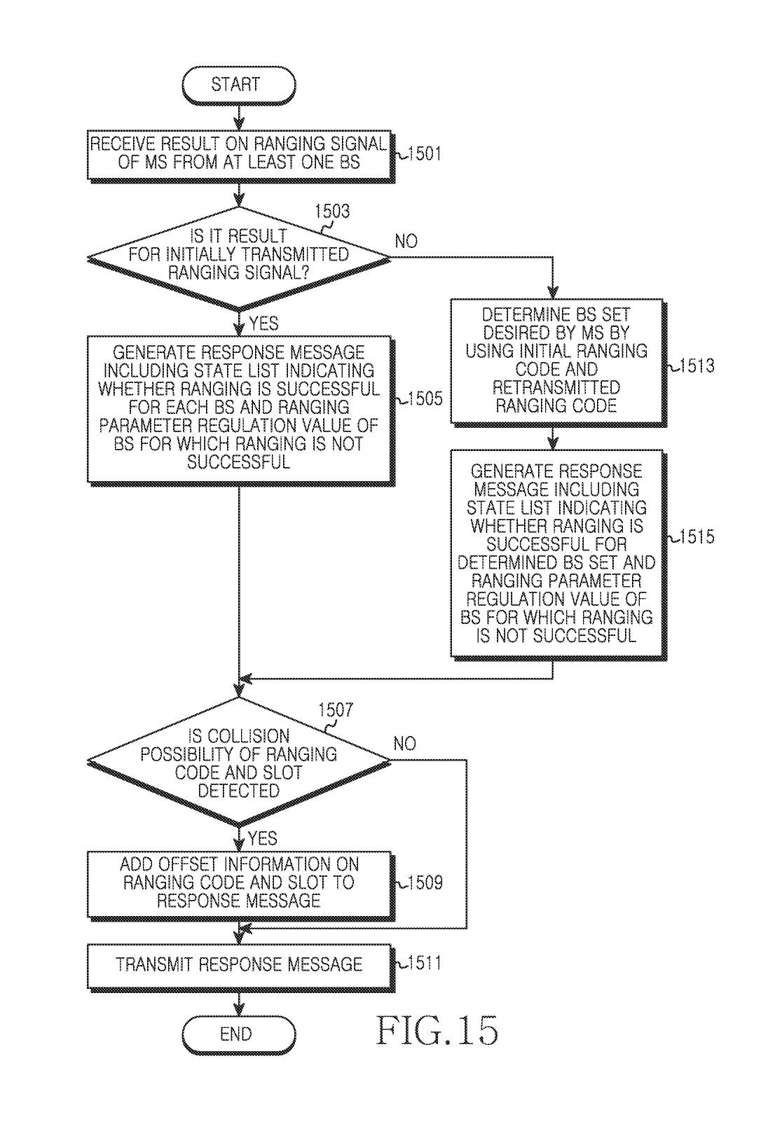

FIG. 15 is a flowchart illustrating a process of a central controller for performing ranging in a wireless communication according to an embodiment of the present disclosure.

Referring to FIG. 15, the central controller 307 receives a signal indicating a result on a ranging signal of the MS from at least one BS at operation 1501. Herein, the signal indicating the result on the ranging signal of the MS includes at least one of a ranging code, a ranging slot, a ranging success/failure state, and a ranging parameter regulation value (e.g., time, frequency, and power regulation values).

At operation 1503, the central controller 307 determines whether the received ranging result is a result for a signal initially transmitted from the MS 300 or a signal retransmitted from the MS 300. Herein, if there is no ranging code and ranging slot information pre-stored for the MS 300 and reported by the BS, the central controller 307 determines that the result is for the ranging signal initially transmitted from the MS 300. Otherwise, if there is the pre-stored ranging code and ranging slot information, the central controller 307 determines that the result is for the result on the ranging signal retransmitted from the MS 300.

If it is the result for the initially transmitted ranging signal, proceeding to operation 1505, the central controller 307 generates a response message including a ranging state information list indicating whether ranging is successful for each BS on the basis of the received ranging result and a ranging parameter regulation value of a BS for which ranging is not successful.

At operation 1507, the central controller 307 detects a collision possibility of the ranging code and the ranging slot. That is, the central controller 307 detects whether there is a possibility of selecting the same ranging code and ranging slot if the ranging code and the ranging slot are reselected on the basis of ranging codes and ranging slots initially selected by a plurality of MSs. For example, it is determined whether there is a possibility that a ranging code and ranging slot reselected by an MS A and a ranging code and ranging slot reselected by an MS B are equal to each other by considering all BS combination indices that can be selected by the MS A and the MS B. If the possibility of the collision of the ranging code and the ranging slot is not detected, the central controller 307 directly proceeds to operation 1511.

Otherwise, upon the detection of the possibility of the collision of the ranging code and the ranging slot, at operation 1509, the central controller 307 may allocate a code offset and a slot offset for avoiding a ranging signal collision to at least one MS among a plurality of MSs, and may add the allocated code offset and slot offset to a corresponding response message.

Thereafter, proceeding to operation 1511, the central controller 307 transmits a generated response message to at least one BS which transmits a result on ranging signal reception of the MS. In this case, the central controller 307 may select one BS and thus request to transmit a response message to the MS.

Meanwhile, if it is determined that the ranging signal reception result received from the at least one BS is a result for a retransmitted ranging signal, at operation 1513, the central controller 307 determines a BS set for which the MS intends to perform ranging by using a pre-stored initial ranging code and ranging slot of a corresponding MS and a retransmitted ranging code and ranging slot. That is, since the central controller 307 is aware of other parameters except for a BS combination index among parameters included in Equation (1) or Equation (2), the central controller 307 can calculate the BS combination index, and can confirm the BS set for which the MS intends to perform ranging on the basis of the calculated BS combination set.

At operation 1515, the central controller generates a response message including a ranging state list indicating whether ranging is successful for the determined BS set and a ranging parameter regulation value of a BS for which ranging is not successful in the determined BS set. Thereafter, returning to operation 1507, the central controller repeats the subsequent steps.

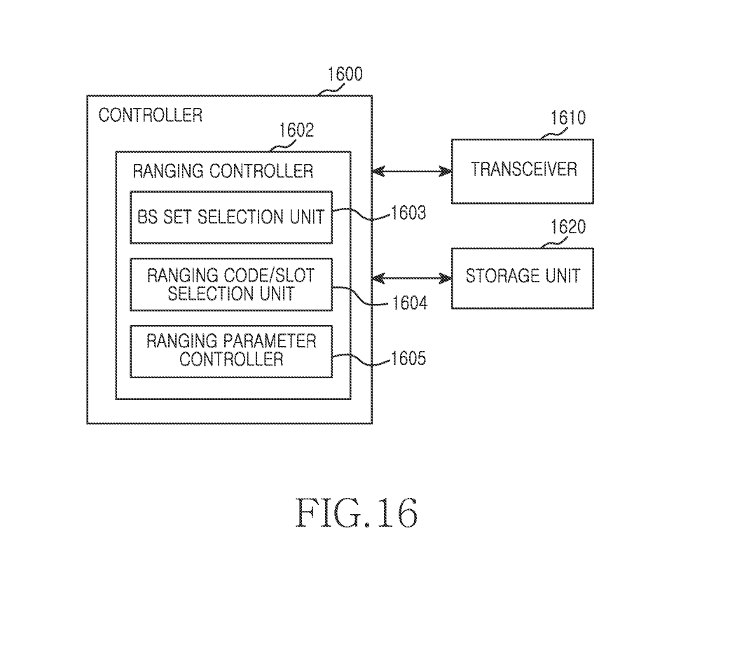

FIG. 16 is a block diagram of an MS in a wireless communication system according to an embodiment of the present disclosure.

Referring to FIG. 16, the MS includes a controller 1600, a transceiver 1610, and a storage unit 1620. In particular, the controller 1600 includes a ranging controller 1602.

The controller 1600 controls and processes an overall operation of the MS. According to the present disclosure, the controller 1600 includes the ranging controller 1602 to control and process a function for transmitting a ranging signal. In particular, the ranging controller 1602 includes a BS set selection unit 1603, a ranging code/slot selection unit 1604, and a ranging parameter controller 1605 to control and process a function for performing the ranging process of FIG. 13.

That is, the BS set selection unit 1603 selects a BS set for performing ranging. Herein, the BS set selection unit 1603 may select the BS set on the basis of at least one of downlink signal's reception strength, a downlink signal's signal-to-noise ratio, each BS's load information, and each BS's type and ranging class. In addition, the BS set selection unit 1602 may select the BS set by using a well-known CoMP set configuration method, a cell clustering method, a handoff method, etc.

The ranging code/slot selection unit 1604 selects a ranging code and a ranging slot for ranging. When a ranging signal is transmitted initially for the ranging, the ranging code/slot selection unit 1604 may select the ranging code and the ranging slot either randomly or according to a predetermined method. On the other hand, if the ranging signal is retransmitted for the ranging, as shown in Equation (1) or Equation (2), the ranging code/slot selection unit 1604 reselects the ranging code and the ranging slot on the basis of an initially selected ranging code and ranging slot, values α and β predetermined by the central controller, a BS combination index indicating a BS for performing ranging, a code offset, and a slot offset.

The ranging parameter controller 1605 acquires a ranging parameter regulation value from a ranging response signal received from the BS, and thereafter regulates ranging parameters according to the acquired ranging parameter regulation value. Herein, the ranging parameter implies time, frequency, and Tx power.

The transceiver 1610 processes a function for transmitting and receiving a signal with respect to the BS under the control of the controller 1600. For example, the transceiver 1610 receives a downlink preamble signal from at least one BS under the control of the controller 1600, and processes a function for transmitting a ranging signal.

The storage unit 1602 stores a variety of programs and data required for an operation of the MS, and stores a variety of information required to transmit the ranging signal. For example, the storage unit 1602 stores information on a ranging code and ranging slot shared by a plurality of BSs, and stores the values α and β for reselecting the ranging code and the ranging slot.

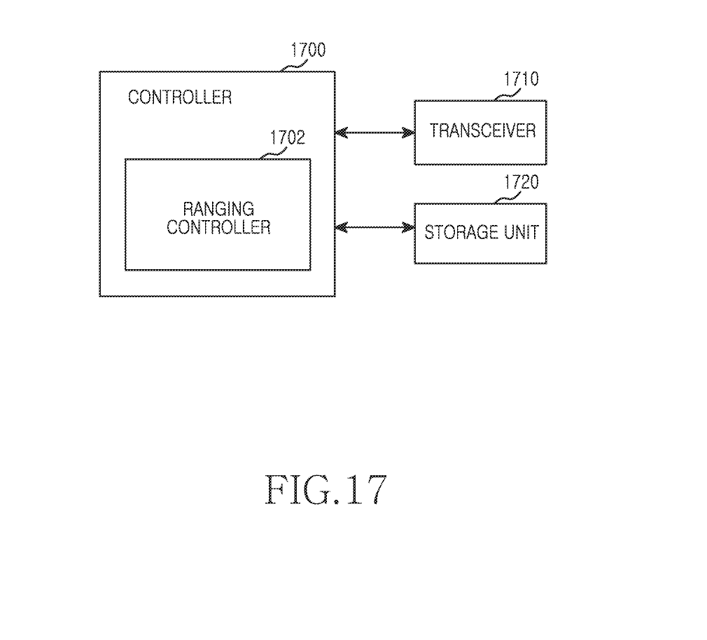

FIG. 17 is a block diagram of a BS in a wireless communication system according to an embodiment of the present disclosure.

Referring to FIG. 17, the BS includes a controller 1700, a transceiver 1710, and a storage unit 1720. In particular, the controller 1700 includes a ranging controller 1702.

The controller 1700 controls and processes an overall operation of the BS. According to the present disclosure, the controller 1700 includes the ranging controller 1702 to control and process a function for performing a ranging process of FIG. 14. That is, upon receiving a ranging signal from the MS, the ranging controller 1702 determines whether there is a need for regulating a ranging parameter such as time, frequency, and power to determine whether ranging is successful, and controls and processes a function for reporting a result on ranging signal reception to the central controller. In particular, if the ranging is not successful, the ranging controller 1702 controls and processes a function for generating a ranging parameter regulation value for regulating time, frequency, and power, and for reporting the generated ranging parameter regulation value to the central controller.

The transceiver 1710 processes a function for transmitting and receiving a signal with respect to the central controller under the control of the controller 1700. For example, the transceiver 1710 performs a function for receiving a ranging signal of the MS in a wireless fashion under the control of the controller 1700, and for transmitting a result on ranging signal reception to the central controller via a backhaul.

The storage unit 1720 stores a variety of programs and data required for an operation of the BS, and stores a variety of information for ranging. For example, the storage unit 1720 may store information on a ranging code and ranging slot shared by a plurality of BSs, and may store the values α and β for reselecting the ranging code and the ranging slot.

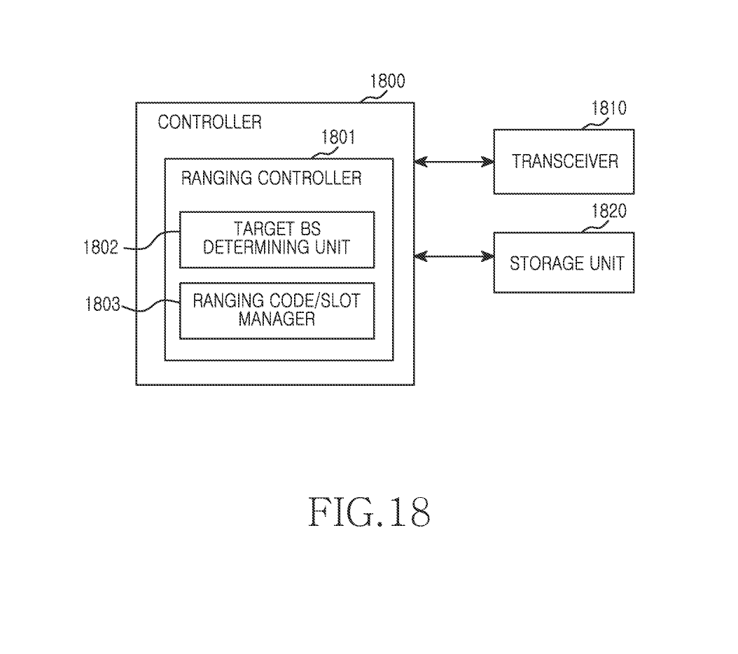

FIG. 18 is a block diagram of a central controller in a wireless communication system according to an embodiment of the present disclosure.

Referring to FIG. 18, the central controller includes a controller 1800, a transceiver 1810, and a storage unit 1820. In particular, the controller 1800 includes a ranging controller 1801.

The controller 1800 controls and processes an overall operation of the central controller. According to the present disclosure, the controller 1800 includes the ranging controller 1801 to control and process a function for facilitating ranging of the MS. That is, the ranging controller 1801 includes a target BS determining unit 1802 and a ranging code/slot manager 1803 to control and process the function for facilitate the ranging of the MS by performing the operation of FIG. 15.

That is, the target BS determining unit 1802 controls and processes a function for determining a BS for which the MS intends to perform ranging, and for providing the MS with ranging statue information indicating a ranging success/failure state of the determined BS and a ranging parameter regulation value of a BS for which ranging is not successful among the determined BSs. In this case, the target BS determining unit 1802 may determine the BS for which the MS intends to perform ranging on the basis of MS's initially selected ranging code and ranging slot, reselected ranging code and ranging slot, predetermined values α and β, code offset, and slot offset. If the MS initially transmits a ranging signal, the target BS determining unit 1802 cannot determine a target BS of the MS, and thus controls and processes a function for providing the MS with a ranging result of all BSs which report a ranging signal reception result of the MS.

The ranging code/slot determining unit 1803 detects a collision possibility of the ranging code and the ranging slot. That is, the ranging code/slot determining unit 1803 detects whether there is a possibility of selecting the same ranging code and ranging slot if the ranging code and the ranging slot are reselected on the basis of ranging codes and ranging slots initially selected by a plurality of MSs. For example, it is determined whether there is a possibility that a ranging code and ranging slot reselected by an MS A and a ranging code and ranging slot reselected by an MS B are equal to each other by considering all BS combination indices that can be selected by the MS A and the MS B. Upon the detection of the possibility of the collision of the ranging code and the ranging slot, the ranging code/slot manager 1803 controls and processes a function for allocating a code offset and a slot offset to avoid a ranging signal collision with at least one MS among a plurality of MSs.

In addition, the ranging controller 1803 controls and processes a function for predetermining the values α and β for selecting the MS's ranging code and ranging slot to share the values with a plurality of MSs and a plurality of BSs. Herein, α and β may be determined according to Equation (3).

The transceiver 1810 processes a function for transmitting and receiving a signal with the BS under the control of the controller 1800. For example, the transceiver 1810 processes a function for receiving a signal indicating a ranging signal reception result from at least one BS under the control of the controller 1800, and for transmitting a ranging result of each BS to the MS via the BS.

The storage unit 1820 stores a variety of programs and data required for an operation of the central controller, and stores a variety of information required to facilitate the ranging of the MS. For example, the storage unit 1820 stores information on a ranging code and ranging slot shared by a plurality of BSs, and stores the values α and β for reselecting the ranging code and the ranging slot. In addition, the storage unit 1820 stores information on a ranging code and ranging slot initially selected or reselected by each MS.

Although a method of selecting a ranging code and a ranging slot is described above, the same method can also apply to a case of selecting only the ranging code according to a design rule. For example, the MS may select only the ranging code and then transmit the ranging code by using a common ranging region, and the central controller may confirm a BS set for which the MS intends to perform the ranging on the basis of an initially selected ranging code and a reselected ranging code.

According to the present disclosure, an MS selects a plurality of BSs and RSs for ranging in a wireless communication system, thereby preventing the ranging from being performed on an unnecessary BS or RS, and the ranging is performed simultaneously on the selected plurality of BSs and RSs by using a common ranging region, thereby decreasing the number of times of transmitting a ranging signal by the MS and a time required for a ranging process. In addition, since a ranging code and slot are adaptively changed according to whether the ranging is successful for the plurality of BSs and RSs selected by the MS, there is an advantage in that a central controller can easily recognize the BS and RS selected by the MS.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A ranging method of a Mobile Station (MS) in a wireless communication system, the method comprising:
selecting at least one Base Station (BS) for performing ranging;
transmitting a ranging signal by using a common ranging region shared by a plurality of BSs; and
receiving a response signal, including a ranging result of at least one BS which received the ranging signal, from a central controller.

2. The method of claim 1, wherein the transmitting of the ranging signal by using the common ranging region shared by the plurality of BSs comprises randomly selecting any one of a ranging code and a ranging slot.

3. The method of claim 1, further comprising:
after receiving the response signal including the ranging result, determining a BS for reperforming the ranging on the basis of the response signal;
reselecting at least one of a ranging code and a ranging slot on the basis of the determined BS; and
retransmitting the ranging signal on the basis of the reselected ranging code and ranging slot.

4. The method of claim 3, wherein the determining of the BS for reperforming the ranging on the basis of the response signal comprises:
determining whether the ranging is successful for all of the selected BSs according to information included in the response signal and indicating whether the ranging is successful for the at least one BS; and
if it is determined that there is at least one BS for which the ranging is not successful among all of the selected BSs, determining the at least one BS for which the ranging is not successful as the BS for reperforming the ranging.

5. The method of claim 3, wherein the reselecting of the at least one of the ranging code and the ranging slot comprises:
determining a BS combination index for indicating the determined BS; and
reselecting at least one of the ranging code and the ranging slot by using at least one of a currently selected ranging code and ranging slot, the BS configuration index, a predetermined ranging code hopping unit and ranging slot hopping unit, and at least one of the code offset and slot offset received from the central controller.

6. A method of a central controller for performing ranging of a Mobile Station (MS) in a wireless communication system, the method comprising:
receiving a ranging result on a ranging signal of the MS from at least one Base Station (BS); and
transmitting the ranging result of the at least one BS to the MS.

7. The method of claim 6, wherein the transmitting of the ranging result of the at least one BS to the MS comprises:
determining whether the ranging signal of the MS is an initially transmitted ranging signal; and
if the ranging signal of the MS is the initially transmitted ranging signal, transmitting all of the received ranging results to the MS,
wherein the ranging result includes at least one of a ranging success/failure state of each BS and a ranging parameter regulation value of a BS for which the ranging is not successful.

8. The method of claim 7, further comprising:
if the ranging signal of the MS is a retransmitted ranging signal, determining at least one BS for which the MS is to perform the ranging by using the initially transmitted ranging signal and the retransmitted ranging signal from the MS; and
transmitting the ranging result of the determined BS to the MS.

9. The method of claim 8, wherein the at least one BS for which the MS is to perform the ranging is determined by using at least one of a ranging code and ranging slot of the initially transmitted ranging signal, at least one of a ranging code and ranging slot of the retransmitted ranging signal, a predetermined ranging code hopping unit and ranging slot hopping unit, and at least one of a code offset and slot offset of the MS.

10. The method of claim 7, wherein the transmitting of the ranging result of the at least one BS to the MS comprises:
determining a possibility that the ranging code and ranging slot selected by the MS are identical to a ranging code and ranging slot selected by another MS; and
if there is the possibility, allocating a code offset and slot offset for reselecting the ranging code and the ranging slot to the MS.

11. A Mobile Station (MS) apparatus for performing ranging in a wireless communication, the apparatus comprising:
a transceiver configured to transmit and receive a signal; and
a controller configured to select at least one BS for performing ranging, to transmit a ranging signal by using a common ranging region shared by a plurality of BSs, and to receive a response signal, including a ranging result of at least one BS which received the ranging signal, from a central controller.

12. The apparatus of claim 11, wherein the controller randomly selects any one of a ranging code and a ranging slot.

13. The apparatus of claim 11, wherein the controller determines a BS for reperforming the ranging on the basis of the response signal after receiving the response signal including the ranging result, for reselecting at least one of a ranging code and a ranging slot on the basis of the determined BS, and for retransmitting the ranging signal on the basis of the reselected ranging code and ranging slot.

14. The apparatus of claim 13, wherein the controller determines whether the ranging is successful for all of the selected BSs according to information included in the response signal and indicating whether the ranging is successful for the at least one BS, and if it is determined that there is at least one BS for which the ranging is not successful among all of the selected BSs, determines the at least one BS for which the ranging is not successful as the BS for reperforming the ranging.

15. The apparatus of claim 13, wherein the controller determines a BS combination index for indicating the determined BS, and reselects at least one of the ranging code and the ranging slot by using at least one of a currently selected ranging code and ranging slot, the BS configuration index, a predetermined ranging code hopping unit and ranging slot hopping unit, and at least one of the code offset and slot offset received from the central controller.

16. A center controller apparatus for performing ranging of a Mobile Station (MS) in a wireless communication system, the apparatus comprising:
a transceiver configured to transmit and receive a signal;
a controller configured to receive a ranging result on a ranging signal of the MS from at least one Base Station (BS), and to transmit the ranging result of the at least one BS to the MS.

17. The apparatus of claim 16,
wherein the controller determines whether the ranging signal of the MS is an initially transmitted ranging signal, and if the ranging signal of the MS is the initially transmitted ranging signal, transmits all of the received ranging results to the MS, and
wherein the ranging result includes at least one of a ranging success/failure state of each BS and a ranging parameter regulation value of a BS for which the ranging is not successful.

18. The apparatus of claim 17, wherein the controller determines at least one BS for which the MS is to perform the ranging by using the initially transmitted ranging signal and the retransmitted ranging signal from the MS if the ranging signal of the MS is a retransmitted ranging signal, and transmits the ranging result of the determined BS to the MS.

19. The apparatus of claim 18, wherein the controller determines at least one BS for which the MS is to perform the ranging by using at least one of a ranging code and ranging slot of the initially transmitted ranging signal, at least one of a ranging code and ranging slot of the retransmitted ranging signal, a predetermined ranging code hopping unit and ranging slot hopping unit, and at least one of a code offset and slot offset of the MS.

20. The apparatus of claim 17, wherein the controller determines a possibility that the ranging code and ranging slot selected by the MS are identical to a ranging code and ranging slot selected by another MS, and if there is the possibility, allocates a code offset and slot offset for reselecting the ranging code and the ranging slot to the MS.
